(19) United States
(12) Patent Application Publication
(10) Pub. No.: US 2025/0248426 A1
(43) Pub. Date: Aug. 7, 2025

(54) FOOD PRODUCTS INCLUDING CAROTENOIDS FOR IMPROVED COLORING AND METHODS OF MAKING THE SAME

(71) Applicant: Terramino, Inc., Berkeley, CA (US)

(72) Inventors: Joshua Nixon, Berkeley, CA (US); Li-Chien Tsai, Berkeley, CA (US)

(21) Appl. No.: 18/855,150

(22) PCT Filed: Apr. 7, 2023
(86) PCT No.: PCT/US2023/065546

§ 371 Date: Oct. 8, 2024

Related U.S. Application Data
(60) Provisional application No. 63/329,170, filed on Apr. 8, 2022.

(51) Int. Cl. A23L 5/44; A23L 29/00; A23L 29/244; A23L 33/00

(52) U.S. Cl. CPC A23L 5/44; A23L 29/04; A23L 29/244; A23L 33/40

(57) ABSTRACT

Food products and methods of making the same are described, wherein the food products and methods incorporate one or more carotenoids or carotenoid-containing compositions in order to provide the food product with a desired coloring. The desired coloring is maintained in the food product despite subjecting some or all of the ingredients of the food product to harsh conditionings steps (e.g., high pH conditions) during the process of preparing the food product. In some embodiments, the food product is a vegetarian or vegan food product. The food product may be a meat or seafood alternative.

### CROSS-REFERENCE TO RELATED APPLICATIONS

The present application is a § 371 national phase filing of International Patent Application No. PCT/US2023/065546 filed Apr. 7, 2023, entitled “FOOD PRODUCTS INCLUDING CAROTENOIDS FOR IMPROVED COLORING AND METHODS OF MAKING THE SAME”; which claims the benefit of priority to U.S. Provisional Patent Application No. 63/329,170, entitled “FOOD PRODUCTS INCLUDING CAROTENOIDS FOR IMPROVED COLORING AND METHODS OF MAKING THE SAME”, filed Apr. 8, 2022, the entirety of which is hereby incorporated by reference.

### TECHNICAL FIELD

The present application relates to food products having carotenoids incorporated therein for improving the coloring of the food products, as well as methods of preparing food products having improved coloring via the use of carotenoids during the preparation of the food products.

### BACKGROUND

Food preparation often requires exposing an ingredient or a mixture of ingredients to various conditions, some of which may be relatively harsh and/or potentially damaging to one or more ingredients. For example, food processing steps may require exposing ingredients to high temperatures or to relatively high or low pH conditions.

Some conditions to which ingredients are exposed during food processing have a direct effect on the coloring of the ingredients and/or the food produced by the food processing steps. In one non-limiting example, it is known that exposing ingredients to high pH conditions during food processing may alter or destroy pigmentation in the food products, including, but not limited to, natural red, yellow and orange colors. This may be problematic in situations where consumers expect a specific food product to have a specific coloring in order to be considered desirable for consumption, even if the presence or absence of the coloring has no bearing on the actual taste and/or quality of the food product. In fact, consumer studies have shown that even if a food product tastes and has a mouth feel identical or extremely similar to expectations for the food product, consumers will refrain from purchasing the product if it does not have the expected coloring for the food product.

While the addition of artificial coloring to the food product may be an option to overcome the alteration or destruction of natural pigmentation during food production, many consumers desire food products that are free of artificial coloring, such as for health reasons or personal lifestyle choices. Furthermore, artificial coloring may not be able to fully achieve the desired hues for a particular food product.

Accordingly, a need exists for food products and food processing methods in which desired coloring is maintained during food processing, and which avoids the use of artificial coloring.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some embodiments, a food product is described, the food product having an amount of one or more carotenoids or carotenoid-containing compositions incorporated therein. The amount of the one or more carotenoids or carotenoid-containing compositions incorporated into the food product is selected to provide the food product with a desired coloring, such as a red coloring. The one or more carotenoids or carotenoid-containing compositions provide the food product with a desired coloring that does not deteriorate even when the food product (including during the process of preparing the food product) is exposed to harsh conditions, such as high pH conditions and/or high temperature conditions.

In some embodiments, a method for preparing a food product is described, the method generally comprising the steps of mixing with at least one ingredient of the food product an amount of one or more carotenoids or carotenoid-containing compositions to form a mixture, and exposing at least the mixture, optionally with other ingredients of the food product combined therewith, to a pH environment above 8.5. The amount of the one or more carotenoids or carotenoid-containing compositions incorporated into the food product or ingredients of the food product provides the food product with a desired coloring (such as a red coloring) that is not substantially deteriorated upon exposing the mixture or the food product to the pH environment above 8.5.

These and other aspects of the technology described herein will be apparent after consideration of the Detailed Description and FIGURES herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following FIGURES, wherein like reference numerals refer to like parts throughout the various views unless otherwise specified.

FIG. 1 is a flow chart of a method for preparing a food product according to various embodiments of the technology described herein.

### DETAILED DESCRIPTION

Embodiments are described more fully below with reference to the accompanying FIGURES, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

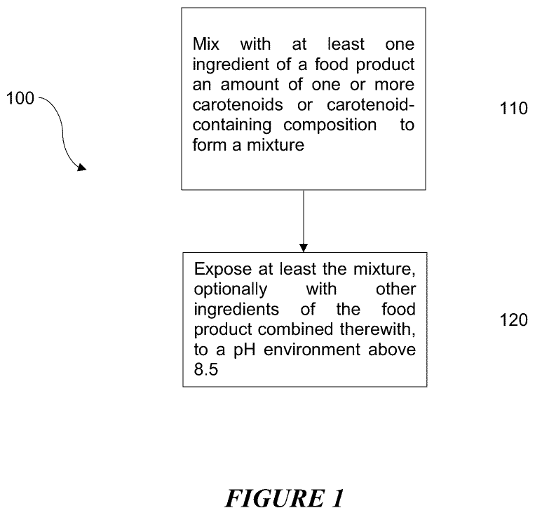

With respect to FIG. 1, a flow chart illustrating embodiments of a method 100 for producing a food product is provided. The method 100 generally includes the step 110 of mixing with at least one ingredient of the food product an amount of one or more carotenoids or carotenoid-containing composition to form a mixture, and the step 120 of exposing at least the mixture, optionally with other ingredients of the food product combined therewith, to a pH environment above 8.5. When exposed to the high pH environment, the coloring imparted by the carotenoids or carotenoid-containing composition (e.g., red coloring) does not deteriorate and is therefore able to be carried through to the final food product, even when further processing steps are carried out (some of which may include further exposure to harsh conditions).

The food product formed via the method 100 is generally not limited. In some embodiments, the food product is any food product where a specific coloring is desired and/or expected by consumers. The food product may be a vegetarian or non-vegetarian food product. The food product may be a vegan or non-vegan food product. In some embodiments, the food product is a vegetarian and/or vegan product that requires red, yellow or orange coloring to better mimic its non-vegetarian and/or non-vegan analogue. In some embodiments, the food product is a meat alternative, such as a meatless ham product. In some embodiments the food product is a seafood alternative, such as tuna alternative food product.

Step 110 of method 100 generally includes mixing together at least one ingredient of the food product and an amount of one or more carotenoids or carotenoid-containing composition to form a mixture. The number of ingredients of the food product used in this step is not limited, and may include a few as one ingredient, or many or all ingredients of the food product. In some embodiments, at least one of the ingredients of the food product used in step 110 is an oil or a fat (or a combination thereof). Using an oil and/or a fat as one component of the mixture formed with the carotenoids or carotenoid-containing composition may be beneficial due to the carotenoids (whether isolated or as included in a carotenoid-containing composition) being soluble in fat or oil. Thus, by mixing the carotenoids with at least a fat and/or oil ingredient of the food product, this helps to provide homogenous mixing of the carotenoids into the mixture and helps to ensure the carotenoids remain present in the food product through subsequent mixing steps, such as mixing with further ingredients of the food product.

As discussed previously, step 110 involves the use of one or more isolated carotenoids, one or more compositions including carotenoids (i.e., a carotenoid-containing composition), or a combination thereof. The isolated carotenoids or carotenoid component of the carotenoid-containing composition used in step 110 are generally not limited, and may include one more type of any known carotenoids. Exemplary, though non-limiting carotenoids that may be used individually or in any combination, include lycopene, β-carotene, β-Apo-8′-carotenal lutein, canthaxanthin, astaxanthin and zeaxanthin. Regardless of whether isolated carotenoid or carotenoid-containing composition is used, any form or chemical structure of the carotenoid or carotenoid component can be used, such as when a carotenoid has multiple isomeric forms. In embodiments where a carotenoid-containing composition is used, any fruit or vegetable extract including one or more carotenoids can be used as the source of carotenoids in step 110. For example, compositions such as annatto, annatto extract, carrot oil, turmeric, paprika, paprika extract (e.g., paprika oleoresin), riboflavin, saffron, tomato lycopene extract, tomato lycopene concentrate, turmeric, and turmeric oleoresin, contain a sufficient amount of carotenoids as to be useful as the carotenoid source in the methods and food products described herein. In some embodiments, lycopene extract, such as tomato lycopene extract is preferred. The lycopene extract may include, for example, 0.1 wt % lycopene, 0.5 wt % lycopene, 1 wt % lycopene, or 2 wt % lycopene.

In some embodiments where a red color is desired for the food product, the carotenoid used in step 110, whether in isolated form or as a component of a composition, includes at least lycopene.

The specific amount of carotenoid provided in step 110 is generally not limited, provided that the amount of carotenoid provided imparts the desired color to the food product with which it is mixed. In some embodiments, the amount of carotenoid provided is any amount that provides the final food product with the desired red color, even after subjecting the food product or various mixtures of ingredients used in the process of making the food product to harsh conditions, such as high pH and/or high temperature conditions.

In embodiments where the carotenoid is provided as a component of a carotenoid-containing composition, the amount of carotenoid-containing composition provided in step 110 may from about 0.001 wt % to about 10 wt % of the total weight of the mixture or food product, such as about 0.01 wt %, about 0.05 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.2 wt %, about 1.5 wt %, about 2.5 wt %, about 5.0 wt %, about 7.5 wt %, or about 10 wt % of the weight of the mixture or food product. The specific amount of carotenoid-containing composition used may be highly dependent on the amount of carotenoid in the carotenoid-containing composition. For example, with carotenoid-containing compositions including relatively small amounts of carotenoid (e.g., 0.1 wt %), a higher amount of carotenoid-containing composition may be needed, whereas when a carotenoid-containing composition including relatively high amounts of carotenoid (e.g., 20 wt %) is used, a smaller amount of the carotenoid-containing composition may be necessary.

In embodiments where the carotenoid is provided in isolated form (e.g., pure or essentially pure carotenoid), the amount of carotenoid provided in step 110 may be from about 5 ppm to 500 ppm on a weight basis. For example, a carotenoid amount of 5 ppm requires 5 millionths of a gram of carotenoid for every gram of the mixture or food product. In some embodiments, the amount of carotenoid provided in step 110 is about 5 ppm, about 10 ppm, about 20 ppm, about 50 ppm, about 100 ppm, about 150 ppm, about 200 ppm, about 250 ppm, about 300 ppm, about 350 ppm, about 400 ppm, about 450 ppm, or about 500 ppm.

Any manner of mixing the one or more carotenoids (or composition including carotenoids) and the at least one ingredient of the food product can be used. Mixing can take place for any period of time, such as whatever period of time required to homogenously mix the carotenoids and food product ingredients.

Once a mixture of the carotenoids or carotenoid-containing mixture and the food product ingredients has been prepared, such as a homogenous mixture of materials, step 120 generally includes exposing at least the mixture to a pH environment above 8.5, such as above 9.0 or above 9.2. While not expressly illustrated in FIG. 1 or described in detail herein, the mixture may be combined with other ingredients of the food product prior to step 120. In some embodiments, all additional ingredients of the food product are combined with the mixture prior to step 120 such that all ingredients of the mixture are exposed to the pH environment above 8.5. In other embodiments, additional ingredients of the food product, though not all ingredients of the food product, are combined with the mixture prior to step 120. In such embodiments, additional ingredients may be added after step 120.

The specific manner in which the mixture is subjected to a pH environment greater than 8.5 is not limited. In some embodiments, the mixture is added to a composition or matrix having a higher pH to thereby expose the mixture to the alkaline environment. Exposing the mixture to the high pH environment can be performed for any suitable reason. In some embodiments, exposing the mixture to the high pH environment helps to create a gel-like material that is required for the final food product. In some embodiments, the gel material created via exposure to the high pH environment is a thermo-irreversible gel. One non-limiting example of the creation of a thermo-irreversible gel from exposure to a pH environment is when the mixture is added to konjac in a high pH matrix.

When subjected to the high pH environment, the carotenoids are not deteriorated, and as such, the high pH environment does not deteriorate the color provided by the presence of the carotenoids. As a result, the benefit of the pH exposure is obtained (e.g., creation of gel-like material) without sacrificing the coloring provided by the carotenoids. Common natural pigments, such as those from beets, and/or other additives used for coloring will generally deteriorate as a result of the high pH environment, but the presence of the carotenoids in the mixture described herein ensures that the desired coloring imparted by the carotenoids is maintained. For example, anthocyanin will deteriorate in the high pH environment (and in a high temperature environment), but the carotenoids will remain and continue to provide the desired coloring despite exposure to the harsh conditions.

In embodiments where the mixture is processed in such a way as to create the aforementioned thermo-irreversible gel, further coloring, such as through the addition of further carotenoids, cannot be accomplished after the formation of the gel. Accordingly, in such embodiments, it is important that the addition of carotenoids for the purpose of providing the food product with a desired color be carried out prior to formation of the gel.

While not illustrated in FIG. 1, the method 100 may include any number of additional food processing steps. In one example, the method 100 includes at least one additional processing step in which the mixture of ingredients (including carotenoids) is exposed to an elevated temperature. Similar to exposure to the high pH environment, the elevated temperature will not deteriorate the carotenoids, and as such, the coloring of the food product is not deteriorated.

Food products in which carotenoids are incorporated therein to provide a desired coloring that withstands harsh conditions are also described herein. In some embodiments, the food product includes an amount of one or more carotenoids or carotenoid containing composition incorporated therein. As discussed previously with respect to method 100, the specific type of carotenoid (whether isolated or as part of a carotenoid-containing composition) used is generally not limited provided the carotenoid provides the food product with a desired coloring (e.g., red, orange, or yellow). A single carotenoid or any combination of carotenoids can be used to make up the amount of carotenoid provided in the food product, including whether isolated or part of a carotenoid-containing composition. As discussed previously, the one or more carotenoids can be provided in isolated form or as part of a composition including the carotenoids (e.g., fruit or vegetable extracts).

In some embodiments, the carotenoid content of the food product is provided by the inclusion of at least one or more of lycopene (isolated or as part of an extract or concentrate), annatto, carrot oil and paprika. In some embodiments, the carotenoid source included in the food product may be entirely lycopene, annatto, carrot oil or paprika.

The specific amount of carotenoid provided in the food product is not limited. The amount of carotenoid included in the food product is generally selected to provide a desired amount of coloring to the food product. For example, in some embodiments where a lighter red coloring is desired, the amount of carotenoids may be reduced, while in other embodiments where a darker and/or more vibrant red coloring is desired, the amount of carotenoids may be increased. Similar or identical ranges as described previously with respect to step 110 for isolated carotenoids and carotenoid-containing compositions can be used in the disclosed food products.

The specific food product in which the amount of one or more carotenoids is incorporated is generally not limited. The food product may be a vegetarian food product or a non-vegetarian food product. The food product may be a vegan food product or a non-vegan food product. In some embodiments, the food product is a meat alternative or a seafood alternative. In one non-limiting example, the food product is a food product that includes glucomannan as an ingredient. In some embodiments, the glucomannan component of the food product is present in the food product because the good product include konjac. In other embodiments, the glucomannan is present in the food product is extracted from a material naturally containing glucomannan, such as konjac. For example, the food product may be a glucomannan-containing seafood alternative such as a tuna alternative food product. In another example, the food product may be a glucomannan-containing meat alternative such as a ham meat alternative food product.

In some embodiments, the food product preferably includes as an ingredient at least a fat and/or oil component. The fat and/or oil component of the food product may be useful in helping to incorporate the amount of one or more carotenoids into the food product, due to the solubility of the carotenoid in the fat or oil component. As discussed in greater detail previously, the carotenoid may be mixed with the fat and/or oil component of the food product as part of the process of making the food product to help ensure the carotenoid is incorporated into and maintained in the food product.

In some embodiments, the food product is free of artificial coloring, such as FD&C#40 Allura Red. In such embodiments, the food product obtains its desired coloring from the carotenoids incorporated therein, and thus does not require artificial coloring to support the desired coloring of the food product. Eliminating artificial coloring from the food product may be beneficial in terms of serving consumer bases that desire food products devoid of artificial ingredients.

In some embodiments, the food product itself may have a high pH value, such as a pH above 8.0, above 8.5, above 9.0, or above 9.2. In some embodiments, the pH of the food product is in the range of from about 8.0 to about 9.5. In such food products, the food product having a pH in the range of from 8.0 to 9.5 is able to maintain a desired coloring due to the presence of the carotenoids, which are able to withstand the high pH environment. This may be considered an unexpected result, since most known ingredients used for imparting coloring to food products, including natural coloring that may be included in one or more ingredients of the food product, are known to deteriorate and lose their coloring when exposed to high pH environments. The same issue may be presented when the food product is exposed to elevated temperatures. While many ingredients or additives typically relied on for imparting a desired coloring (e.g., red) may degrade at elevated temperatures, the carotenoid component of the food product described herein will not deteriorate under elevated temperatures. Accordingly, even when exposed to high pH and/or high temperatures, the food products described herein desirably maintain their coloring.

While not limited to meat and seafood alternatives, the technology described herein may be particularly useful when used in the preparation of meat and seafood alternatives such that the meat and seafood alternatives more closely resemble the analogue meat or seafood product.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

I/We claim:

1. A food product, comprising:
one or more food product ingredients; and
an amount of one or more carotenoids or carotenoid-containing compositions incorporated with the one or more food product ingredients, the amount of the one or more carotenoids or carotenoid-containing compositions incorporated into the food product being selected to provide the food product with a red coloring;
wherein the food product has a pH in the range of from about 8.0 to about 9.5.

2. The food product of claim 1, wherein one of the one or more food product ingredients is glucomannan.

3. The food product of claim 1, wherein one of the one of more food product ingredients is fat or oil.

4. The food product of claim 3, wherein the one or more carotenoids or carotenoid-containing compositions is mixed with the fat or oil.

5. The food product of claim 1, wherein the carotenoid or the carotenoid component of the carotenoid-containing composition is lycopene.

6. The food product of claim 1, wherein the carotenoid-containing composition is selected from the group consisting of carrot oil, paprika and annatto.

7. The food product of claim 1, wherein the food product is a vegetarian or vegan food product.

8. The food product of claim 1, wherein the food product is a meat alternative or a seafood alternative.

9. The food product of claim 1, wherein the food product is free of artificial coloring.

10. The food product of claim 1, wherein the food product comprises carotenoids, and the amount of the carotenoids is from about 5 ppm to about 500 ppm.

11. The food product of claim 1, wherein the food product comprises a carotenoid-containing composition, and the amount of the carotenoid-containing composition is from about 0.001 wt % to about 10 wt % of the total weight of the food product.

12. A method for preparing a food product, the method comprising:
mixing with at least one ingredient of the food product with an amount of one or more carotenoids or carotenoid-containing compositions to form a mixture and impart the food product with a color; and
exposing at least the mixture, optionally with other ingredients of the food product combined therewith, to a pH environment above 8.5;
wherein the coloring imparted to the mixture is not substantially deteriorated upon exposing the mixture to the pH environment above 8.5.

13. The method of claim 12, wherein the at least one ingredient of the food product is mixed with an amount of one or more carotenoids, and one of the one or more carotenoids is lycopene.

14. The method of claim 12, wherein the at least one ingredient of the food product is mixed with an amount of one or more carotenoid-containing compositions, and one of the one or more carotenoid-containing compositions selected from the group consisting of carrot oil, paprika and annatto.

13. The method of claim 12, wherein one of the at least one ingredient of the food product is glucomannan.

15. The method of claim 12, wherein one of the at least one ingredient of the food product is fat or oil.

16. The method of claim 12, further comprising:
heating at least the mixture, optionally with other ingredients of the food product combined therewith, to an elevated temperature;
wherein the coloring imparted to the mixture is not substantially deteriorated upon heating the mixture to the elevated temperature.

17. The method of claim 12, wherein the food product is vegan or vegetarian.

18. The method of claim 12, wherein the food product is a meat alternative or a seafood alternative.
